(19) United States
(12) Patent Application Publication
(10) Pub. No.: US 2019/0333541 A1
(43) Pub. Date: Oct. 31, 2019

(54) INTEGRATED VIRTUAL SCENE PREVIEW SYSTEM

(71) Applicant: LIGHTCRAFT TECHNOLOGY LLC, Culver City, CA (US)

(72) Inventors: Newton Eliot Mack, Culver City, CA (US); Philip R. Mass, Culver City, CA (US); Kyle E. Murphey, Culver City, CA (US)

(21) Appl. No.: 16/349,767

(22) PCT Filed: Apr. 17, 2017
(86) PCT No.: PCT/US17/27960

§ 371 Date: May 14, 2019

Related U.S. Application Data
(60) Provisional application No. 62/421,939, filed on Nov. 14, 2016.

(51) Int. Cl. G11B 27/036; H04N 5/262; H04N 5/232; H04N 5/265; H04N 5/06; H04N 9/802; G11B 27/10

(52) U.S. Cl. CPC G11B 27/036; H04N 5/2621; H04N 5/23299; G11B 27/10; H04N 5/06; H04N 9/802; H04N 5/265

(57) ABSTRACT

A system for combining live action and virtual images in real time that enables automatic time and position alignment between the live action and virtual images, and provides a self-contained tracking sensor that enables wireless and multi-camera operation.

### CROSS-REFERENCE TO RELATED APPLICATIONS

This application is a 35 U.S.C. § 371 National Stage Entry of International Application No. PCT/US2017/027960, filed Apr. 17, 2017, which claims the priority benefit of U.S. Provisional Patent Application No. 62/421,939, filed Nov. 14, 2016, all of which are incorporated herein by reference in their entirety for all purposes.

### BACKGROUND

The present disclosure relates generally to technologies for combining real scene elements from a video, film, or digital type camera with virtual scene elements from a real time 3D rendering engine into a finished composite image. More specifically, the disclosure relates to methods for simplfying and automating the process of combining these two separate types of images in real time.

The state of the art in combining live action imagery with imagery from a real time 3D rendering engine is a process that requires considerable precision. Methods for doing this have existed for many years, but the various technologies involved had similar problems that prevented this useful and powerful method from being widely adopted in the entertainment production industry.

There are several different areas of technology that all have to work well for the finished image to be seamless: camera position and orientation tracking, lens optical tracking, 3D rendering of a matched synthetic image, and finally compositing the two separately generated images together, with or without a blue or green screen based process. These various technologies are all different enough that they are usually developed by separate companies. For example, Intersense Corporation of Billerica, Mass. builds an optical-inertial tracker, the IS1200, that can track 6DOF motion accurately. Preston Cinema Systems of Santa Monica, Calif. makes a remote lens controller that can read the current position of lens adjustment rings. The VizRT company of Bergen, Norway makes a real time 3D engine that is frequently used in news and sports broadcasts. The Ultimatte Corporation of Chatsworth, Calif. builds a real time green screen removal and keying tool in common use in the same news and sports broadcasts. However, despite the various technologies all existing for some time, their combined use to create finished images in real time for entertainment production is extremely rare.

### SUMMARY

The difficulty comes when all the above-mentioned separate technologies have to be integrated seamlessly under intense production use. There are several separate problems that occur, both on the tracking sensor side and on the image integration side.

On the tracking side:

Each system has a different amount of time delay inherent to its operation, requiring a set of data delay queues between each component.

The software interfaces between the various systems change, and cause incompatiblity.

Since tracking data is typically not timestamped, the operator must match up time syncronization problems “by eye” by moving the camera rapidly, and looking for time mismatches between the motion of the live action and the synthetic images.

Multiple high-bandwidth sensors and camera feeds, each with its own connection requirements, typically lead to a large bundle of cables connecting the camera to the rest of the system, which is undesireable for camera operators and prevents the use of standard wireless video links.

Many sources of tracking data are not synchronized to the exact frame rates used by video and digital cameras, which can cause strange time artifacts.

Multicamera switching is difficult and expensive, due to the need to put the switcher behind three complete camera +2D+3D systems.

Many tracking systems require a time-consuming survey to resolve the overall position of the tracking reference markers, or are very sensitive to the existing lighting conditions or the tracker being partially occluded.

The large power consumption and bandwidth required by most tracking systems prevents them from being integrated into existing camera systems.

On the image integration side:

Measuring and specifying the offset between the coordinate system of the tracking sensor and the sensor of the scene camera is complex and time-consuming to get it right, and is prone to error with inexperienced operators.

The typical physical separation of the 3D engine component and the 2D compositing systems requires fixed-bandwidth synchronized hardware interfaces between them, such as HDSDI, that limit higher quality images such as linear scene-referred data or depth data from being transferred.

The same separation between 2D and 3D systems means that rendered images must be rendered with distortion if a precise match between live action and synthetic images is desired, but most 3D rendering engines cannot do this.

Most 3D rendering engines are not designed to be frame synchronized to HDSDI-type output hardware, and it is difficult to adapt them to this purpose using custom programming

Separate tracking data ‘sidecar’ files are difficult to keep track of when the number of clips grows into the hundreds, thousands, and tens of thousands.

Splitting up and editing these tracking data files becomes very complex, and requires interpreting edit decision list (EDL) files generated by different nonlinear editing systems.

Provided herein is a new real time method for combining live action and rendered 3D imagery that does not depend on adjusting synchronization delays by eye, and provides an automated method of matching tracking data with the associated live action frame. It can also remove the need to integrate multiple tracking technologies from different companies. In addition, provided herein is a method for tracking and lens data that can be automatically ‘stamped’ with timecode, so that subsequent matching of this data with the corresponding video frame is straightforward.

Furthermore, the tracking system can be self-contained, with only a low bandwidth tracking data connection to the 2D compositing and 3D rendering stages, so that wireless operation can be achieved. All of the pose and lens tracking data can be synchronized to precisely match the frame rates of professional video and film production equipment. In addition, the tracking data can be embedded directly into the camera's live audio or video signal, removing the need for a separate tracking data link. This single addition enables all of the video, audio, and tracking information from a scene camera to be transmitted over a standard wireless video link. This addition also enables multicamera virtual shoots to be achieved with multiple cameras and tracking sensors, but a single central computer handling compositing and 3D rendering, as the incoming video would always have matching incoming tracking data in the audio channel.

In addition, the system does not require an external surveying step, and can handle a wide range of set lighting conditions. The system can also handle portions of the sensor being occluded. In addition, the tracking technology can be directly integrated into an existing video or television camera.

The offsets between the tracking sensor and the scene camera can be rapidly and automatically determined. The connection between the 2D compositing and 3D rendering engine into a flexible data path instead of a fixed-bandwidth dedicated hardware interface, to handle custom resolutions and data formats, such as depth data. Furthermore, the 3D rendering engine is not required to correctly render distortion. The rendering engine can transfer rendered frames at precise video frame rates without having to run the overall engine at precise video frame rates, and the amount of custom code integration with the 3D render engine is minimized.

In addition, the tracking data for post production can be stored in a format integrated with the video and audio files, so that no separate metadata file is necessary. The tracking data can automatically be extracted from a standard edited sequence from a nonlinear editor for use in VFX.

Various embodiments of an integrated virtual scene preview system are provided in the present disclosure. In one embodiment, a virtual scene preview system includes a self-contained tracking sensor that measures the position and orientation of a motion picture camera, using a combination of optical feature recognition and inertial measurement. The optical feature detection can be artificial fiducial targets, naturally occurring features that can be recognized with machine vision, or other camera based methods. In a present embodiment, the optical features used are artificial fiducial markers such as the AprilTag system, a technique well known to practitioners in this field. In a preferred embodiment, the machine vision is performed by a standard single board computer with a GPU, in order to decode the fiducial markers at around 20-60 Hz. The fiducial vision system is used to establish the overall absolute position of the tracker within the world.

Since optical position measurement typically has a fair amount of noise, this measurement technique is combined with an inertial measurement unit, or IMU. This can be a six degree of freedom IMU manufactured by Analog Devices of Norwood, Mass. Inertial devices have a very fast update rate, and as such their data output can be synchronized with external triggering signals, but they tend to drift rapidly. Combining external position and orientation measurement with an inertial system is a technique well known to practitioners in this field. This data combining can be done in a dedicated real time high speed microcontroller made by the Atmel Corporation of San Jose, Calif. This microcontroller is connected to the IMU to read the high speed IMU inertial information, which is transmitted at rates up to 2400 Hz.

Since a goal of this self-contained tracking sensor can be to measure the precise position and location of the television or motion picture camera at the time the camera captures a frame of the scene, the camera and the sensor are synchronized. This uses two external signals, termed genlock and timecode in the television and motion picture industry. Typically, an external ‘sync source’ is used to generate these two signals. The sync source can be a standard Denecke genlock and timecode generator, for example.

The genlock signal regulates the precise timing of when the sensor captures its position and orientation and when the camera captures its live action frame of the scene, implemented as a repeating pulse of a specified frequency for the exact video frame rate used. Common video frame rates can include 23.98, 24.00, 25.00, and 29.97 frames per second, as well as other frame rates yet to be standardized. Timecode specifies which frame number is being captured, in a format of hours:minutes:seconds:frames. The timecode is then written into both the video frame captured by the camera, and the pose (position and orientation) information captured by the sensor, so that the sensor motion can be automatically matched with a specific frame of video later on in the system. The genlock and timecode can be read directly by the high speed microcontroller. The current fused pose estimation is read when the genlock pulse is received, and it is timestamped with the current timecode value and sent out as a tracking data packet.

To measure the current optical parameters of the lens, the amount of rotation of the lens zoom and focus rings is known. This can be achieved by encoders connected to the outside of the lens zoom and focus rings, and read by an encoder box which is then connected to the tracking sensor. This encoder box can communicate with the tracker over a serial connection, and the encoder read can be triggered by the same external sync pulse used by the real time microcontroller.

In a current embodiment, the lens encoder data is incorporated into the tracking data packet. This data packet can be sent to external devices over a serial type connection. This data can also be encoded into audio form, and sent to the scene camera's audio input, to embed the tracking data into an audio channel for later use. When the tracking data is embedded into the scene camera's audio data, the use of multicamera virtual switching is then enabled, so that when three camera feeds are switched through a standard HDSDI switcher into a single compositing and rendering system, the incoming camera video always has the correct matching tracking data packet along with it. This removes the need for multiple compositing and rendering units to handle a multicamera shoot, and considerably simplifies operations.

The scene camera's real time live action output can be connected to a PC with a high-speed data connection to transfer live action video. This connection can be a HDSDI cable connected to a HDSDI video I/O board installed in the PC, made by AJA Inc. of Grass Valley, Calif.

The tracking sensor's serial data output is also connected to the same PC. Since the data transfer is just position, orientation, and lens ring position, the data bandwidth is small, and can be achieved by either a standard serial cable, a wireless serial link, or embedded into the camera's audio data. The serial data connection can be a standard RS232 connection. To combine the live action image with a virtual image, the virtual image is rendered with the same position and orientation as the live action image, and then combined with the live action image. This can be achieved on the PC with three pieces of software running at the same time: a 2D compositing system, a separate 3D rendering engine, and a plug-in to the 3D engine that enables communication between the two.

The 2D compositing software receives the incoming serial and video data through the serial and video I/O interface, and looks up the lens optical parameters using the incoming lens position data and a calibration file on the PC. This can be a lens calibration file generated by a system such as is described in U.S. Pat. No. 8,310,663. The 2D compositing software then sends a packet to the plugin residing in the 3D engine that contains camera pose info, lens optical data, and a frame identifier that is linked to the original timecode value.

To ensure that the 2D and 3D images will be properly aligned, the offset between the tracking sensor and the scene camera's sensor are determined. Since the optical parameters of both the tracking camera's lens and the scene camera's lens are known (via the lens calibration file described in the previous paragraph), the relative positions between the two sensors can be calculated by pointing the tracking sensor's camera forward to be parallel with the scene camera, and then tilting up the scene camera so that both cameras are now pointing toward the overhead fiducial targets. As long as both cameras can see at least four fiducial targets, the pose of both cameras can be calculated. The offset to the tracking camera's sensors is then simply the difference between the two poses.

When the corresponding frame of video is received from the scene camera, the 2D compositing software reads it in, processes the video to remove the blue or green background, and reads the frame's timecode. The blue or green screen removal process can be achieved through a variety of algorithms well known to practitioners in this field. This keying process can be achieved by a color difference key followed by a despill operation that clamps the level of blue or green to the next highest color level. The 2D compositing software can then store this processed live action frame in a queue.

The 3D engine plug-in reads the incoming frame data packet, and configures the 3D engine to render an image of the 3D scene from the pose and lens field of view indicated by the data packet. The frame is typically rendered oversize to account for later lens distortion. The rendered frame is placed in a shared memory location along with the frame identifier number, and a “frame ready” signal is sent to the 2D compositing application. This signal can consist of a cross-process semaphore.

The 2D compositing application receives the “frame ready” signal, reads in the rendered frame from the 3D application, and then uses the frame identifier to automatically match it to the correct keyed 2D frame. The 2D compositing application then composites the rendered image from the 3D engine along with the keyed 2D live action image. This can be achieved using the matte generated by the previous color difference keying operation.

The 2D compositing application then sends the composited image out the video I/O card, and optionally records the tracking data. The tracking data can be embedded into one of the audio channels of the live composited output.

In post production, large numbers of takes are typically edited together to create a final edit. Since the tracking data is stored in one of the audio tracks that is associated with the video footage, when the edit is finished, the complete tracking data for the edit can be extracted by exporting the audio from the complete edit, and then running the audio file through a data extractor to convert the audio data into a data format (such as Maya ASCII) that can be read into standard post-production tools (such as Maya, sold by the Autodesk Corporation of San Rafael, Calif.)

Disclosed herein is a tracking sensor which includes an inertial measurement unit, a computing device and a controlling device. The controlling device can be configured to receive genlock signals, timecode signals, and pose updates from the computing device and high speed inertial data (e.g., 800-2400 Hz) from the inertial measurement unit. The controlling device can also be configured to drift-correct the pose updates using the high speed inertial data to form smoothed video pose data. And additionally, the controlling device can be configured to read the smoothed pose when the genlock signal arrives and associate the smoothed pose with the timecode signal being read at the same time and generate tracking data packets synchronized with the genlock and timecode signals and stamp each data packet with the timecode stamp associated with the timecode signal. The genlock signals can be received from a sync generator associated with a multi-camera video production. And the timecode signals can be received from a timecode generator associated with a multi-camera video production.

Also disclosed herein is a method which includes: sending a composited output image out over a video capture card; converting a camera and lens tracking data packet associated with the composited output image into an audio waveform; inserting the audio waveform into an audio channel of a video image of the output image; simultaneously recording the composited output image and the audio waveform contained in the video image; and after the recording, transporting the tracking data along with the video data. The transporting can include digitally copying the video file and does not use an external metadata file. The method can also include before the sending, compositing the output image from a live action scene camera and a 3D rendering engine.

Additionally disclosed herein is a method which includes: video editing a composited video having tracking data embedded in an audio channel of an output image of the video; exporting an audio clip of an edited sequence of the edited composited video; and reconstructing the tracking data from the audio clip using a tracking data extractor. The reconstructing can include passing the audio clip through extractor software. The method can also include after the reconstructing, using the tracking data to render a set of high quality images of a 3D scene to replace the original real time rendered 3D images. The video editing can use a video editing system that keeps the tracking audio synchronized with the video.

Further disclosed herein is a system which includes: a computing device; a compositing application running on the computing device; a 3D rendering engine running on the computing device; and a plugin configured to generate rendered frames requested by the compositing application. The rendered frames can be views of a virtual scene that are defined by the incoming tracking data packets. The compositing application can handle the timing of receiving the rendered frames from the plugin and combining them with the matching live action video frames. That is, the compositing application can integrate rendered frames from the 3D engine with live action frames from a video source.

Even further disclosed herein is a method which includes: drift-correcting pose updates using high speed (e.g., 800-2400 Hz.) inertial data to form smoothed pose; reading the smoothed pose when a genlock signal is received and associating the smoothed pose with a timecode signal being received at the same time; and generating tracking data packets synchronized with the genlock and timecode signals and stamped with a timecode stamp associated with the timecode signal. This method can further include sending the tracking data packets to a 3D rendering system for rendering a virtual image that matches the pose of a live action camera image.

Still further disclosed herein is a method which includes: calculating camera pose when a genlock signal is received including drift correcting the pose using high speed inertial data to form a smoothed pose; generating tracking data using the smoothed pose and synchronized with received genlock and timecode signals; and directly embedding the tracking data into a camera video signal and thereby synchronizing with an associated video frame to provide real time tracking data that is synchronized and transmitted along with a camera video signal. The embedding can be as a real time serial data packet or an audio waveform.

Disclosed herein is a method which includes embedding tracking data with timecode directly into a video stream at a camera during recording where the embedding includes information required to render a virtual set being contained within a frame of video that is being passed through a live camera output. The tracking data can include the camera position, orientation, lens optical information, and timecode at time of capture. The method can further include automatically switching an associated tracking data along with a camera signal when a digital camera switcher is used to switch between multiple live camera signals during a television or video production. The method can further include automatically changing a perspective of a 3D background of a virtual background to match that of a current live camera view.

Also disclosed herein is a method which includes: synchronizing a rendered virtual frame with a frame number embedded therein and a live action video image with a frame number embedded therein by comparing and matching frame numbers of the tracking data and the video image. The synchronizing can include connecting the same timecode source to both a scene camera and a tracking data system. The comparing and matching can be done by a frame ingest module that receives the rendered virtual image along with its frame number stamp. The synchronizing can be done without any hand adjustment due to each virtual image and live action image having a unique frame number that is derived from timecode. The method can further include after the synchronizing, compositing the live action video image to the rendered virtual image.

Additionally disclosed herein is a method which includes comparing timecodes on rendered virtual frames and timecodes on live action video frames, and if the timecodes match, compositing the two frames together.

Further disclosed herein is a method which includes storing tracking data for post-production in an audio channel of an output composited image. The storing can include converting the tracking data into an audio waveform and inserting the audio waveform into an audio channel of a video image.

Even further disclosed herein is a method which includes editing a composited video in post production including automatically extracting tracking data from a resulting edited sequence. The extracting can include exporting the audio channel of the sequence that contains tracking data to a separate audio file, and running extractor software that converts the audio waveform in the audio file into tracking data files that can be used in post production.

Still further disclosed herein is a tracking sensor which includes: inertial measurement unit (IMU); an embedded controller which is low power of less than 1 W (for example); the controller being configured to receive inertial data from the IMU; an embedded computing device which is low power of less than 15 W (for example); and the computing device being connected to the controller by a data connection. The controller and the computing device can enable self-contained synchronized tracking over volumes greater than 50 M×50 m×10 m (including 100 M×100 m×10 m) and with a power consumption of less than 15 W. This enablement is due to only needing to see 4-5 targets at a time to solve pose.

### BRIEF DESCRIPTION OF THE DRAWINGS

The foregoing and other features and advantages of the present invention will be more fully understood from the following detailed description of illustrative embodiments, taken in conjunction with the accompanying drawings.

FIG. 1 is a perspective view of an embodiment in accordance with the present disclosure.

FIG. 2 is a side view of a tracking sensor in multiple adjustment configurations in accordance with an embodiment of the present disclosure.

FIG. 3 is a top view of a tracking sensor in accordance with an embodiment of the present disclosure.

FIG. 4 is a block diagram that depicts the data flow through a tracking sensor of the present disclosure.

FIG. 5 depicts a live action and virtual image before and after being combined in accordance with the present disclosure.

FIG. 6 is a block diagram that depicts the data flow through the 2D compositing and 3D rendering system of the present disclosure.

FIG. 7 is a screen capture that depicts a user interface in accordance with an embodiment of the present disclosure.

FIG. 8 is a block diagram that depicts the method of operation of an integrated scene preview system in accordance with an embodiment of the present disclosure.

### DETAILED DESCRIPTION

The following is a detailed description of the presently known best mode(s) of carrying out the inventions. This description is not to be taken in a limiting sense, but is made merely for the purpose of illustrating the general principles of the inventions.

A rapid, efficient, reliable system is disclosed herein for combining live action images on a moving camera with matching virtual images in real time. Applications ranging from video games to feature films can implement the system in a fraction of the time typically spent individually tracking, keying, and compositing each shot with traditional tools. The system thereby can greatly reduce the cost and complexity of creating composite imagery, and enables a much wider usage of the virtual production method.

The process can work with a real-time video feed from a camera, which is presently available on most “still” cameras as well. The process can work with a “video tap” mounted on a film camera, in systems where the image is converted to a standard video format that can be processed.

An objective of the present disclosure is to provide a method and apparatus for rapidly and easily combining live action and virtual elements, to enable rapid control over how an image is generated.

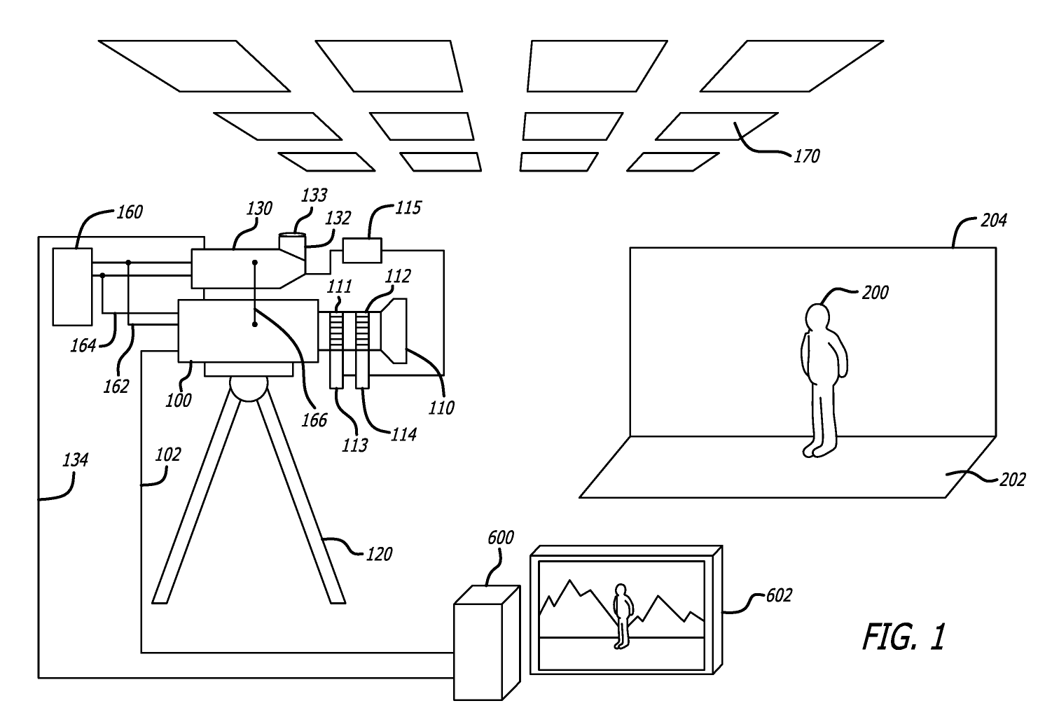

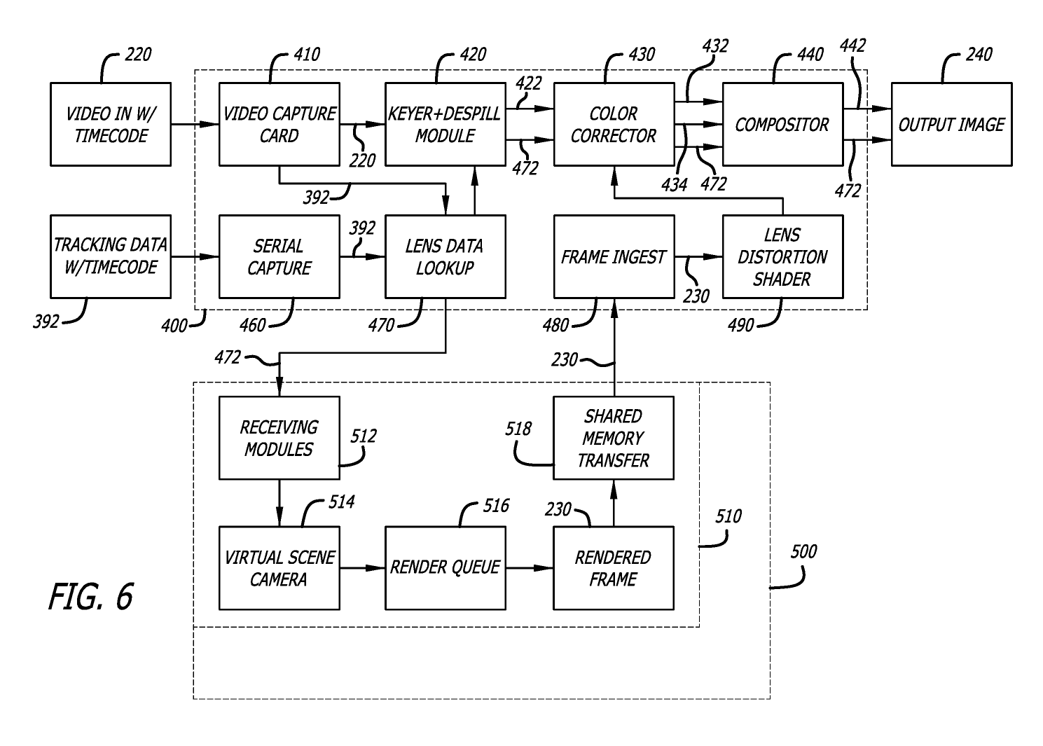

FIG. 1 depicts an embodiment of the present disclosure. A scene camera 100 with lens 110 is positioned to capture a live action video image 220 (FIG. 6) of a subject 200 standing on a ground plane 202 in front of a background 204. The subject(s) 200, for example, can be actors, props and physical sets. The background 204 may be painted a blue or green color to enable separation of subject 200 from the background 204. This paint can be Digital Green or Digital Blue paint from Composite Components Corporation in Los Angeles, Calif.

The scene camera 100 can be mounted on a camera support 120, which can be a tripod, dolly, Steadicam, or handheld-type support. A tracking sensor 130 is rigidly mounted to scene camera 100. The tracking sensor 130 contains a tracking camera 132 with a wide angle lens 133.

The tracking camera 132 is used to recognize optical markers 170. Optical markers can consist of artificially-generated fiducial targets designed to be detected by machine vision, or naturally occurring features. These markers 170 can be located on the ceiling, on the floor, or anywhere in the scene that does not obstruct the scene camera's view of subject 200. In a preferred embodiment, these markers 170 are located on the ceiling.

To synchronize the operation of the scene camera 100 with the tracking sensor 130, an external sync generator 160 can be used. This generates a genlock signal 162 and a timecode signal 164. The genlock 162 and timecode 164 are connected to both the scene camera 100 and the tracking sensor 130. The genlock signal 162 consists of periodic pulses that provide an overall synchronization of the timing of the capture of images in scene camera 100 and the capture of tracking data from tracking sensor 130. The timecode 164 provides a time stamp in hours:minutes:seconds:frames format that identifies exactly which hour, minute, second, and frame is being recorded at any instant. This sync generator 160 can be a Denecke SB-T timecode generator and tri-level sync generator.

Tracking sensor 130 can have a serial connection 134 that sends serial tracking data 392 (FIG. 6) to a separate computer 600 (FIG. 1) with attached color calibrated monitor 602. In addition, scene camera 100 can have a live video connection 102 that sends live video with timecode 220 out to computer 600. Live video connection 102 can be of a variety of standards capable of live video transfer, and for example can be the HD-SDI digital video standard.

Optionally, tracking sensor 130 can also send tracking data 392 (FIG. 6) directly to scene camera 100 through data connection 166 (FIG. 1). This connection can be serial, audio, or any other standard connection used by modern digital cameras, and for example can be an audio signal that is being used to transfer tracking data 392.

Referring to FIG. 1, lens 110 can have zoom ring 111 and focus ring 112 that can rotate to adjust the zoom and focus of lens 110. The motion of zoom ring 111 and focus ring 112 are tracked by zoom sensor 113 and focus sensor 114. These sensors can be encoders made by U.S. Digital of Vancouver, Wash. The zoom and focus sensors 113 and 114 are connected to encoder box 115. Encoder box 115 interprets the signals from zoom and focus sensors 113 and 114, and sends the data to tracking sensor 130. The encoder box 115 can communicate with tracking sensor 130 with a standard serial interface, and the timing of the sensor read can be triggered by tracking sensor 130 at the same time that the pose data is read.

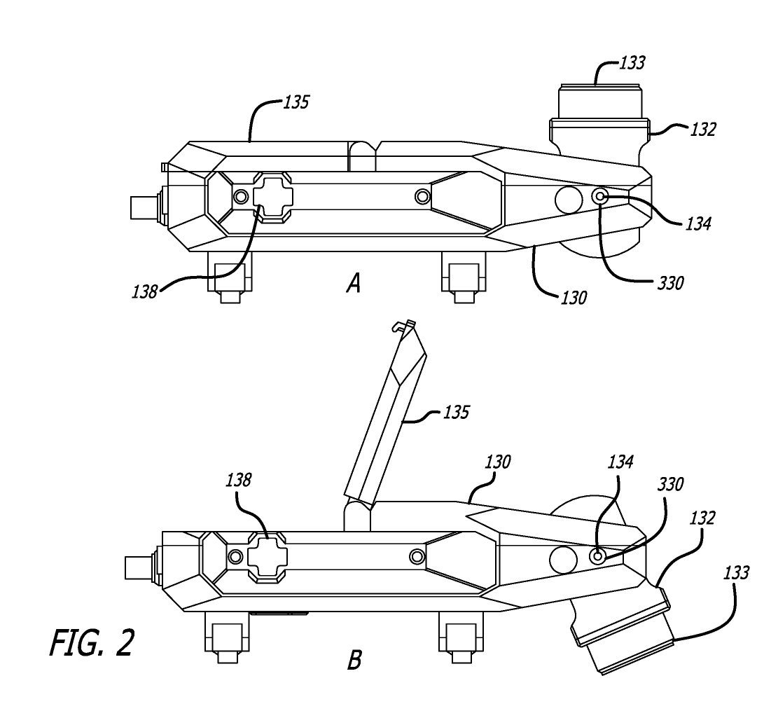

An embodiment of the present disclosure is illustrated in FIG. 2. A tracking sensor 130 is shown with a tracking camera 132 and a wide angle lens 133. Tracking camera 132 can be mounted on a pivot 134 so that tracking camera 132 can be rotated up or down as shown in A or B to better see optical markers 170. In addition, tracking camera 132 can be pointed straight forward, so that it can see the same objects as camera 100. In this way, calculating the alignment between the tracking sensor 130 and camera 100 can be easily achieved. The rotation of tracking camera 132 can be measured by rotary sensor 330, which can be a potentiometer. As the precision of standard potentiomenters is not sufficient to determine the precise angle that tracking camera 132 has been positioned to, and the rotation of tracking camera 132 can be restricted to 22.5 degree adjustment angles, for example.

Tracking sensor 130 may also contains LCD 135 and directional button 138. They are used to control the operation of tracking sensor 130, and along with the hardware design of tracking sensor 130 enable self-contained operation. LCD 135 can be flipped up or down as shown in A or B in order to be seen or not seen by the camera operator.

The field of view of wide angle lens 133 is a trade-off between what the lens can see, and the limited resolution that can be processed in real time. This wide angle lens can have a field of view of about ninety degrees, for example, which provides a useful trade-off between the required size of optical markers 170 and the stability of the optical tracking solution.

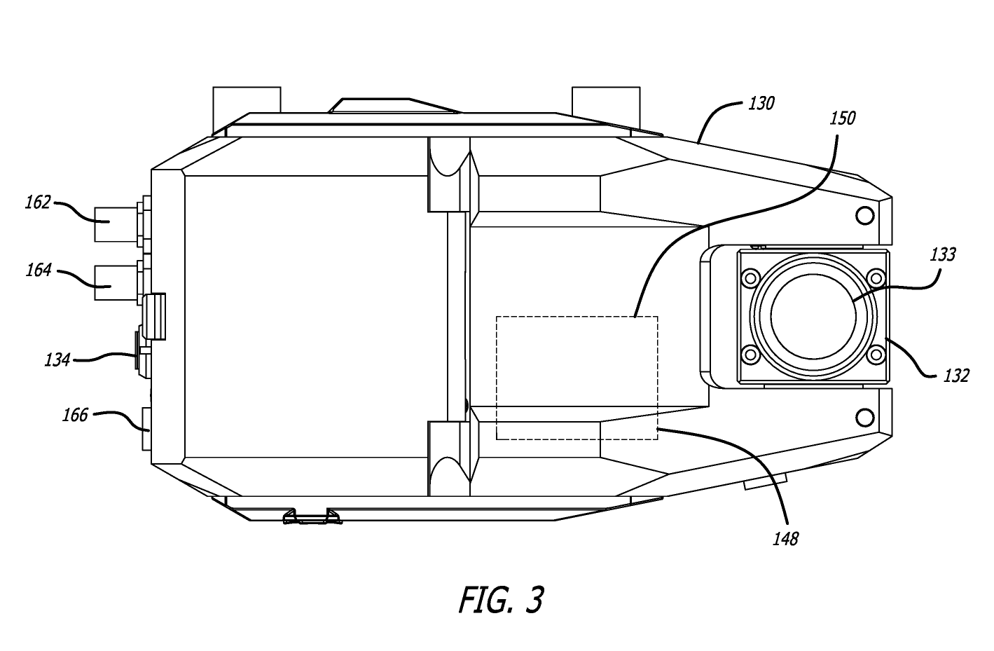

An embodiment of the present disclosure is illustrated in FIG. 3. Tracking sensor 130 can have an adjustable tracking camera 132 with a wide angle lens 133. In addition, tracking sensor 130 can have four connectors on the back, including connectors for genlock 162, timecode 164, a power and serial data connection 134, and an optional direct camera data connection 166. Tracking sensor 130 also contains an inertial measurement unit 148, or IMU. IMU 148 is used along with tracking camera 132 to generate tracking data with timcode 392.

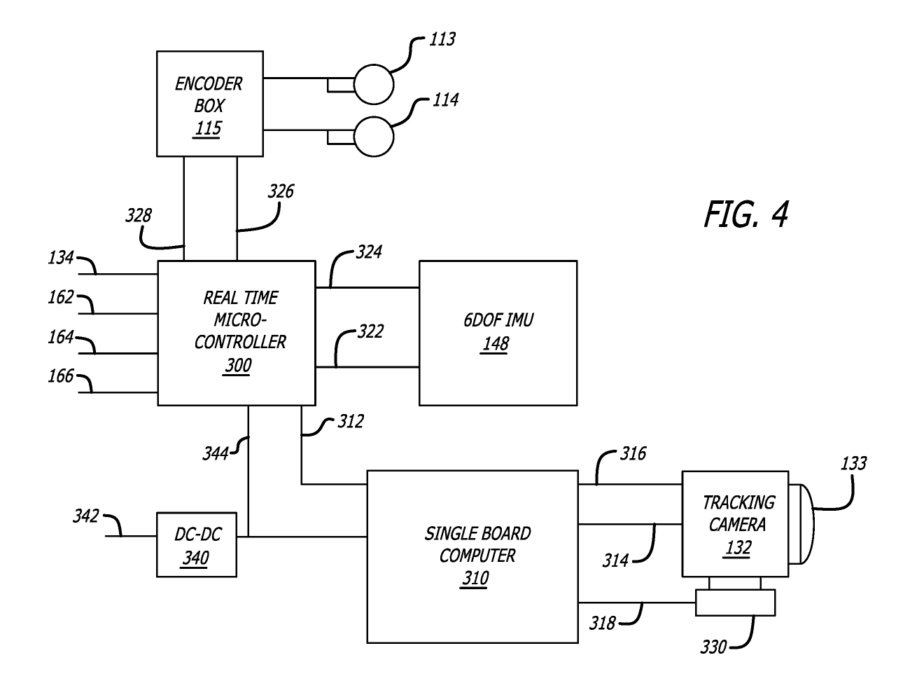

The data flow of tracking sensor hardware 130 is illustrated in FIG. 4. A real time microcontroller 300 is connected to IMU 148 with both a data connection 324 and a synchronization connection 322. Microcontroller 300 can be a 32 bit unit made by Atmel Corporation of San Jose, Calif. IMU 148 can be a six degree of freedom IMU manufactured by Analog Devices Corporation of Norwood, Mass. Data connection 324 can be a high speed SPI serial bus. IMU 148 updates its data very rapidly, up to several thousand times per second. Each time its data is updated, synchronization connection 322 (FIG. 4) is held low so that the IMU's current data can be read by microcontroller 300 over the data connection 324. IMU 148 can be set to an update rate of 800 samples/second. Since the IMU data stream is inherently high speed, the sensor fusion between vision system and IMU can be done locally, or the sensor will require a high bandwidth connection to a host PC, preventing wireless operation.

Microcontroller 300 is also connected to single board computer (SBC) 310 by data connection 312. This connection can also be a high-speed SPI serial bus. And SBC 310 can be a TK1 module made by Toradex AG of Switzerland.

Both microcontroller 300 and SBC 310 can be powered by a DC converter module 340, as shown in FIG. 4. Module 340 takes in unregulated DC power 342 from scene camera 100 or external sources and converts it to regulated voltage 344. DC converter module 340, for example, can be a DC-DC converter made by CUI of Tualatin, Oreg.

SBC 310 is connected to tracking camera 132 by a data connection 316 and a synchronization connection 314. Data connection 316 can be a USB-3 high speed serial connection. Synchronization connection 314 can be a simple GPIO trigger line. And tracking camera 132 can be a monochrome machine vision camera with a global shutter made by Point Grey Research of Richmond, British Colombia.

SBC 310 is also connected to rotary sensor 330 with a data connection 318. In a preferred embodiment, this is an analog voltage driven by rotary sensor 330 and measured with an onboard A/D converter on SBC 310.

SBC 310 continuously captures images from tracking camera 132 and uses machine vision to recognize optical markers 170. Optical markers 170 can be artificial fiducial markers similar to those described in the AprilTag fiducial system developed by the University of Michigan, which is well known to practitioners in the field. To calculate the current position of the tracking sensor in the world, a map of the existing fiducial marker positions must be known. In order to both generate a map of the position of the optical markers 170, a nonlinear least squared optimization can be performed using a series of views of identified targets, in this case called a “bundled solve,” a method that is well known by machine vision practitioners. In a preferred embodiment, the bundled solve calculation is calculated using the open source CERES optimization library by Google Inc. of Mountain View, Calif. (http://ceres-solver.org/nnls_tutorial.html#bundle-adjustment) Since the total number of targets is small, the resulting calculation is small, and can be performed rapidly on SBC 310, so that the tracking remains self-contained.

Once the overall target map is known, and tracking camera 132 can see and recognize at least four optical markers 170, the current position and orientation (or pose) of tracking sensor 130 can be solved. This can be solved with the Perspective Three Point Problem method described by Laurent Kneip of ETH Zurich in “A Novel Parametrization of the Perspective-Three-Point Problem for a Direct Computation of Absolute Camera Position and Orientation.” The resulting target map is then matched to the physical stage coordinate system floor. This can be achieved by placing tracker 130 on the floor and measuring the gravity vector of IMU 148 while keeping the targets 170 in sight of tracking camera 132. Since the pose of tracking camera 132 is known, and the position of tracking camera 132 with respect to the ground is known (as the sensor is resting on the ground), the relationship of the targets 170 with respect to the ground plane 202 can be rapidly solved with a single 6DOF transformation, a technique well known to practitioners in the field.

The transformed camera pose is transmitted to microcontroller 300 over data connection 312 for each frame captured by tracking camera 132. Microcontroller 300 continuously integrates the optical camera pose from SBC 310 with the high-speed inertial data from IMU 148 using a PID (Proportional, Integral, Derivative) method to resolve the error between the IMU pose and the optical marker pose, and to generate a smoothed pose result at a very high rate. The PID error correction method is well known to practitioners in real time measurement and tracking. Since microcontroller 300 and SBC 310 are both embedded, low power devices, their combination enables self contained synchronized tracking over volumes that reach 100 m×100 m×10 m with a power consumption of less than 15 W.

Microcontroller 300 receives both the genlock signal 162 and timecode signal 164 from the sync generator 160. The genlock signal is used to trigger a read of the current combined and error-corrected smoothed pose. The genlock signal is also used to trigger a read of the lens zoom ring encoder 113 and lens focus ring encoder 114 through encoder box 115. Encoder box 115 can be connected to microcontroller 300 through a standard RS232 serial connection 326 and a sync signal line 328. The encoder data is received as a 16 bit number that describes the position of the zoom and focus rings 111 and 112 on the camera from end stop to end stop.

Microcontroller 300 decodes the current time code hour, minute, second, and frame from the incoming timecode signal 164. This decoding can be achieved using the Society of Motion Picture and Television Engineers standard LTC interpretation. Microcontroller 300 then generates a serial packet 392, sent out over serial connection 134, that includes the error-corrected camera pose, current timecode, and current lens encoder position. This way, data packet 392 has data that matches the current frame of video 220 captured by scene camera 100.

In an alternative embodiment, tracking data packet 392 can be turned into an audio signal, and sent out over direct connection 166. In this embodiment, tracking data packet 392 will be stored in one of scene camera 100's audio channels, which removes the need for a physical serial connection 134 and further allows the video and tracking data to be completely self-contained in a single video connection 102. This enables the possibility of switching between the views of multiple scene cameras 100, with the associated camera tracking data packet 392 coming along with the video signal automatically. The tracking data can be stored in the audio signal via a simple 8 bit volume-normalized encoding scheme well understood to practitioners in the art.

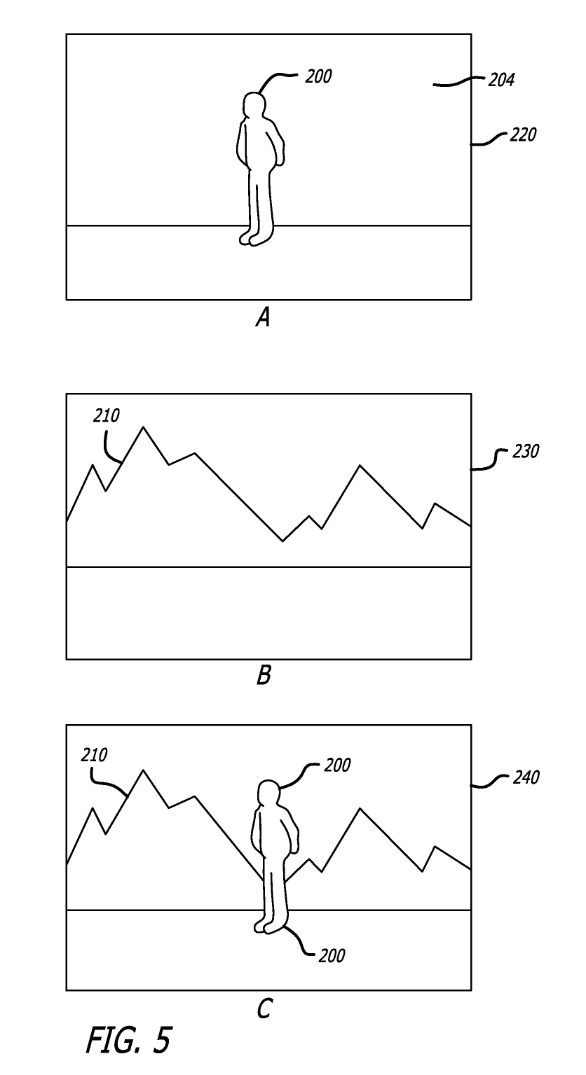

A goal of the present system is illustrated in FIG. 5. The function of tracking sensor 130 is to generate time stamped position, orientation, and lens data 392 that can be used to render a virtual background 230 containing virtual scene imagery 210 shown in B to match with the live action foreground 220 shown in A. The completed composite image 240 with foreground subject 200 and virtual imagery 210 is shown in C of FIG. 5.

The data flow of the software rendering and compositing operation is shown in FIG. 6. The 2D compositing and 3D rendering operations all take place on a standard computer 600 with a video I/O card 410 and a GPU. The video I/O card can be a Kona 4 made by AJA Inc. of Grass Valley, Calif. and the GPU can be a GeForce made by nVidia Incorporated of Santa Clara, Calif.

The software running on computer 600 is divided into three major parts: compositing system 400 and 3D rendering engine 500, which has plug-in 510 running as a separate subcomponent of 3D engine 500.

Inside compositing system 400, the live action video frame 220 is sent from the scene camera 100 over video connection 102 and captured by video capture card 410. Live action frame 220 is then sent to the keyer/despill module 420. This module removes the blue or green background 204, and removes the blue or green fringes from the edges of subject 200. The removal of the blue or green background 204 can be done with a color difference keying operation, which is well understood by practitioners in this field. The despill operation is achieved by clamping the values of green or blue in the live action image 220 to the average of the other colors in that image, so that what was a green fringe resolves to a grey fringe. The keying process generates a black and white matte image called an alpha channel or matte that specifies the transparency of the foreground subject 200, and the combination of the despilled image and the transparency are combined into a transparent despilled image 422 and then sent to color corrector 430.

While this is happening, the incoming tracking data packet 392 can be captured by serial capture interface 460 and interpreted. This data packet 392 is then sent to the lens data lookup table 470. In another embodiment, if the serial tracking data packet 392 has been embedded into the incoming live action video image 220 in an audio channel, video capture card 410 can extract the tracking data packet 392 and send it directly to lens data lookup and transform 470.

Since the coordinate system of tracking sensor 130 is offset from the sensor of camera 100, the coordinate offset between the two sensors should be known. This can be achieved by manual measurement of the offset between the two coordinate origins, or automatically measured. This can be achieved with an automated optical measurement. Since the optical parameters of both the wide angle lens 133 and scene camera lens 110 are known (via the lens lookup table 470 described in the previous paragraph), the relative positions between the two sensors can be calculated by pointing the tracking camera 132 forward to be parallel with scene camera lens 110, and then tilting up scene camera 100 so that both cameras are now pointing toward fiducial targets 170. As long as both cameras can see at least four fiducial targets, the pose of both cameras can be calculated with the same perspective 3-point pose calculation used previously by the tracker 130. The offset to the tracking camera's sensors is then simply the difference between the two poses. Once this is determined, tracking camera 130 can then be rotated back upward without losing the correct offsets, as the various mechanical offsets in pivot 134 are known and the offset between tracker 130 and camera 100 is a constant.

Lens data lookup and transform 470 uses the incoming data from lens encoders 113 and 114 contained in tracking data packet 392 to determine the present optical parameters of zoom lens 110. This lookup can take the form of reading the optical parameters from a lens calibration table file such as that described in U.S. Pat. No. 8,310,663. Lens data lookup also transforms the incoming tracker pose data by the constant offset between tracker 130 and camera 100. A combined data packet 472 containing the current camera 100 pose, lens 110 optical parameters, and a frame number derived from timecode 164 is then sent from compositing system 400 to plugin 510. This can be a UDP packet transferred from one application to another in the same computer 600.

In addition, lens data lookup and transform 470 also transfers data packet 472 back to the keyer/despill module 420. As can be seen from the data flow chart, this tracking data accompanies the live action video frame through the rest of the pipeline, and is output along with the output image 240 for use in post production. This tracking data can be encoded into a simple volume-normalized 8 or 16 bit data encoding, and recorded into one of the audio channels in the HDSDI live video feed of output image 240.

The 3D engine 500 can be running simultaneously on computer 600 with compositing application 400. 3D engine 500 has a plugin 510 that is running inside it, which connects 3D engine 500 to compositing system 400. Plugin 510 has a receiving module 512 which captures combined data packet 472 when it is transmitted from compositing system 400. This can be received by a UDP socket, a standard programming device known to practitioners in this field. Receiving module 512 decodes the camera pose, lens optical parameters and frame number from packet 472.

Receiving module 512 then sets a virtual scene camera 514 with the incoming live action camera pose, lens optical parameters, and frame number. Scene camera 514 is then entered into render queue 516. 3D engine 500 then receives the data from render queue 516 and renders the virtual frame 230. After virtual frame 230 is rendered on the GPU, it is then transferred to shared memory along with its frame number via shared memory transfer 518. This transfer can be achieved in a variety of ways, including a simple main memory copy as well as cross-process direct GPU transfer. In a preferred embodiment, this can be achieved by a copy to main memory.

The plugin 510 does not activate unless receiving module 512 has received a data packet 472. Likewise, no frames are requested of render queue 516 unless receiving module 512 has received a data packet. In this way, 3D engine 500 can be made to output frames 230 that are synchronized with the frame rate of incoming video 220 without requiring the rest of the 3D engine to run at video frame rates. This makes it possible for a 3D engine that was never designed to render synchronized to video (which describes nearly all modern 3D rendering engines originally designed for video games) to produce rendered frames 230 at the precise synchronized rates required by video production.

When shared memory transfer 518 completes its transfer, it sends a signal to a frame ingest 480 that is located in the 2D compositing system 400. This signal can be a cross-process semaphone well known to programming practitioners. Frame ingest 480 then loads the numbered virtual frame 230 from shared memory, and uses the frame number to match it with the corresponding original live action image 220. After the matching process, frame ingest 480 transfers virtual frame 230 to the lens distortion shader 490. Since physical lenses have degrees of optical distortion, virtually generated images have distortion added to them to properly match the physical lens distortion. The lens optical parameters and the lens distortion calculations can be identical to those used in the OpenCV machine vision library, well known to practitioners in machine vision.

Since the barrel distortion commonly found in a wide angle lens causes parts of the scene to be visible that would normally not be seen by a lens with zero distortion, this requires that the incoming undistorted image be rendered significantly oversize, frequently as much as 25% oversize from the target final image. This unusual oversize image requirement makes the direct software connection between compositing system 400 and 3D engine 500 critical, as the unusual size of the required image does not match any of the existing SMPTE video standards used by HDSDI type hardware interfaces.

The lens distortion shader 490 sends distorted virtual image 492 into color corrector 430 where it joins despilled image 422. Color corrector 430 adjusts the color levels of the distorted virtual image 492 and the despilled image 422 using a set of color adjustment algorithms driven by the user to match the overall look of the image. Color corrector 430 can use the standard “lift, gamma, gain” controls standardized by the American Society of Cinematographers in their Color Decision List calculations.

After the user has specified the color adjustments with color corrector 430, the color corrected live action image 432 and color corrected virtual image 434 are sent to a compositor 440. Compositor 440 performs the merge between the live action image 432 and the virtual image 434 using the transparency information, or matte, generated by keyer module 420 and stored in the despilled image 422. In areas of high transparency (such as where the blue or green colored background 204 were seen), the virtual background will be shown, and in areas of low transparency (such as subject 200), the subject will be shown. This together creates output image 240, which is transferred out of compositing system 400 and computer 600 through output link 442. Output link 442 can be the output side of the video capture card 410.

The separation of the compositing system 400 and the 3D render engine 500 has a number of benefits. There are a large number of competing real time 3D engines on the market, and different users will want to use different 3D engines. The use of a simple plug-in that connects the 3D render engine 500 to compositing system 400 on the same computer 600 enables the 3D engine 500 to be rapidly updated, with only a small amount of code in plugin 510 required to update along with the changes in the render engine.

In addition, the use of a separate plugin 510 that receives data packet 472 on its own thread, and places a render request in render queue 516 means that 3D engine 500 is not required to render at a fixed frame rate to match video, which is important as most major 3D engines are not designed to synchronize with video frame rates. Instead, the engine itself can run considerably faster than video frame rate speeds, while the plugin only responds at exactly the data rate requested of it by compositing system 400. In this way, a wide range of render engines that would not typically work with standard video can be made to render frames that match correctly in time with video.

Similarly, the simultaneous use of compositing system 400 and 3D engine 500 on the same computer 600 means that the data interface between the two can be defined completely in software, without requiring an external hardware interface.

The traditional method to combine 3D with 2D imagery required two separate systems connected with HDSDI hardware links. This meant a fixed bandwith link that was very difficult to modify for custom image formats, such as high dynamic range images. In addition, the HDSDI hardware interface has a fixed format that was the same resolution as the image (for example, 1920 pixels across by 1080 pixels vertically.) Since images that are going to be distorted to match wide angle lens values have to be rendered larger than their final size, the use of a fixed resolution hardware interface forces the 3D engine to render with lens distortion included, and very few 3D engines can render physically accurate lens distortion. The use of a software defined data path solves this problem, and places the work of distorting incoming images onto compositing system 200, where the same distortion math can be applied to all incoming images.

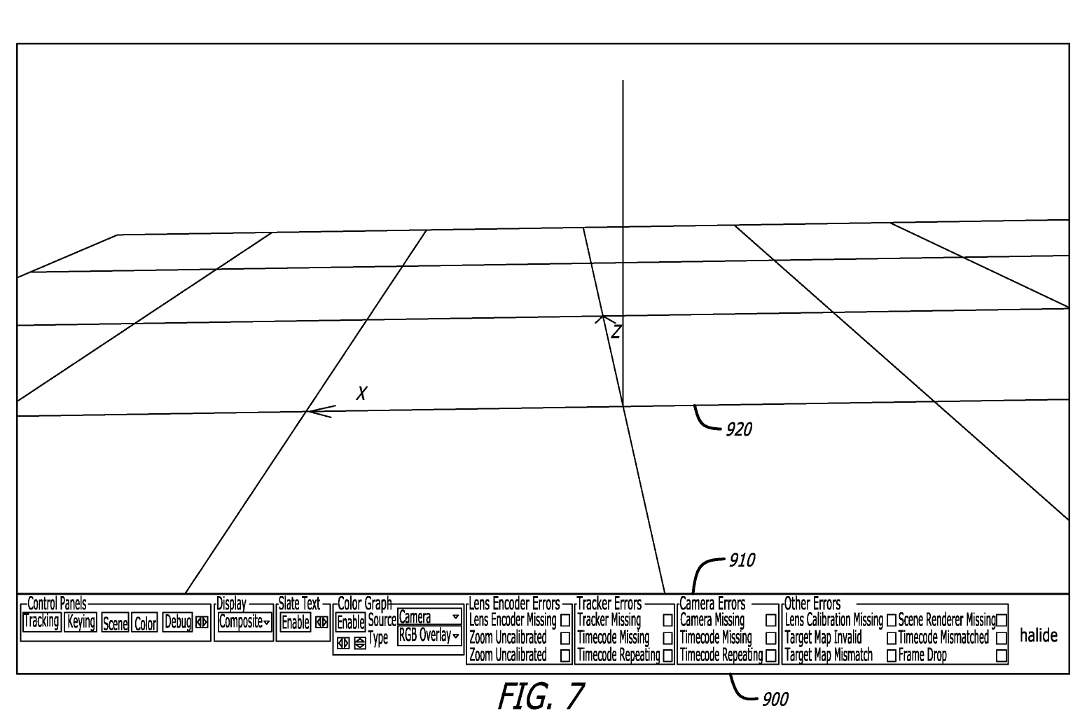

A screen capture of compositing system 400 is shown in FIG. 7. A user interface 900 contains both error lights 910 and a virtual ground grid 920 that will be overlaid with the live action image 220 to verify alignment between the tracking sensor 130 and the scene camera 100.

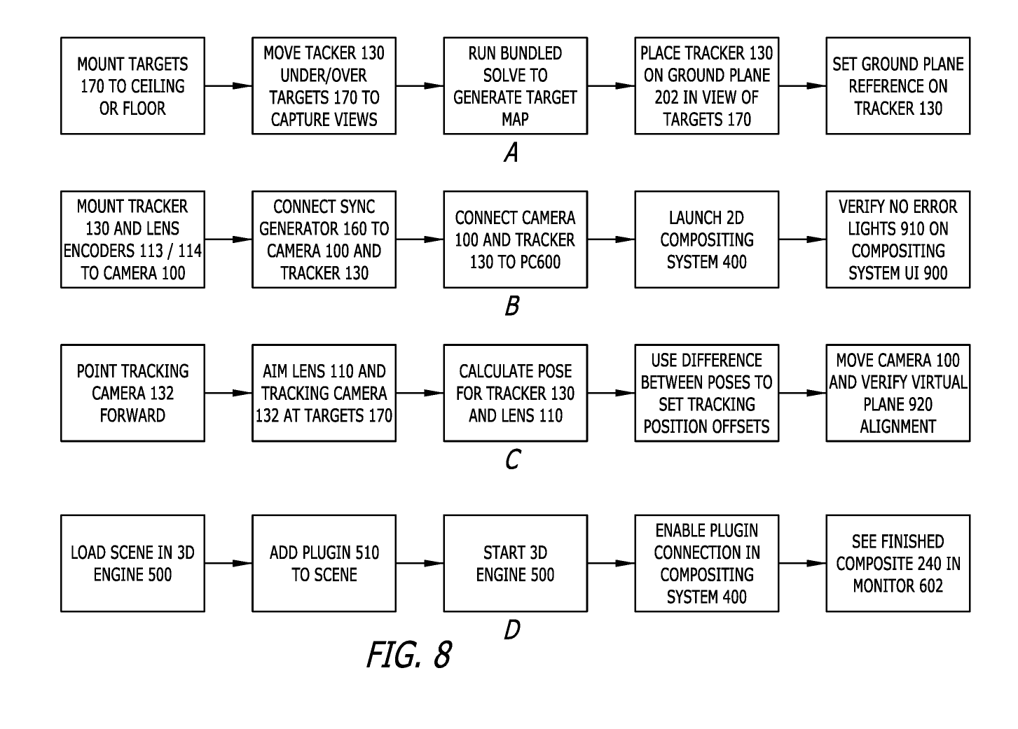

A block diagram depicting the method of operations is shown in FIG. 8. Section A covers the setup of the tracking targets 170, the calculation of their overall location, and the referencing of the ground plane 202 to the targets 170. The first step is to mount targets 170 to a fixed location. This can be either the floor or the ceiling, or other locations where it is convenient to place tracking targets. In the preferred embodiment, tracking targets 170 are placed on the ceiling. After the targets 170 are placed, tracking sensor 130 is placed in view of them and moved around the tracking space to capture multiple views of targets 170. Once a sufficient number of views of targets 170 have been captured from multiple locations, a bundled solve is run on tracking sensor 130 to calculate the relative positions of all the targets 170. The result of the bundled solve is the creation of a target map that contains the 3D positions of each target 170. Once the target map is created, the location of ground plane 202 is calculated with respect to the target map. This can be accomplished by placing tracking sensor 130 on the ground plane 202, so that the tracking camera 132 can see the overhead targets 170 and calculate its current pose. The user then presses a button to tell tracking sensor 130 that this point represents the ground plane 202 location.

Section B of FIG. 8 covers the connection of tracking sensor 130 to camera 100 and PC 600. Tracking sensor 130 and lens encoders 113 and 114 are mounted on camera 100 and lens 110. The timecode and sync generator 160 is connected to camera 100 and tracking sensor 130. Camera 100 and tracking sensor 130 are then connected to PC 600 via data and video cables, or with wireless connections. And this connection can be achieved with cables. Compositing system 400 is then launched on PC 600, and the error lights 910 are checked to make sure that all the connections are correct.

Section C of FIG. 8 covers the alignment of tracking sensor 130 to camera 100 and lens 110, which is important for accurate alignment of the virtual and live action components of composite output image 240. First, tracking camera 132 on tracking sensor 130 is pointed forward, so that the tracking camera 132 and main lens 110 are both pointing in the same direction. Camera 100 is then tilted up so that both scene camera 100 and tracking camera 132 can see tracking targets 130 at the same time. Since the target map with the locations of targets 170 is already known, it is straightforward to calculate the positions of both tracking sensor 130 and lens 110 at the same time, using the pose calculation methods previously mentioned. The offset between the tracking sensor 130 and the camera 100 with lens 110 is then simply the difference between the two calculated pose locations. To verify this, camera 100 is tilted back down until it can see ground plane 202, and the camera is moved back and forth. When the alignment is correct, the movement of virtual ground plane 920 will match the movement of ground plane 202.

Section D of FIG. 8 covers the connection of 3D engine 500 with compositing system 400. A virtual scene is loaded into 3D engine 500. Next, plugin 510 is added to the virtual scene, and 3D engine 500 is started. The plugin connection is enabled in compositing system 400, which begins the data flow between the two systems. Finally, composited image 240 can be seen in monitor 602.

The resulting composited image 240 can be used in a variety of manners. For example, the background 204 can be completely replaced with a virtual background. This is useful when the background location desired is extremely difficult, dangerous, or expensive to base a production in. Alternatively, it is possible to replace only a portion of background 204. This application is typically termed “background replacement.”

In another example, a building set can be built up only to the first story, so that characters can walk in and out of physical doors, but be virtual from the second story upward. This application is generally termed a “set extension.”

In post production, tracking data for a shot is valuable. This can be used by post production applications to render 3D objects that are matched to the perspective of the 2D live action image in the same way that is described here for the real time 3D engine. However, separate tracking data files (frequently termed metadata files) are difficult to keep organized when the number of different video clips becomes large, and the cost of organizing separate data files can rapidly exceed the cost of redoing the tracking from scratch. The tracking data can be stored in one of the audio channels of the output live video.

When the video is captured by a standard recording deck, it is recorded to one of a variety of production file formats. And this can be the ProRes file format created by Apple Computer of Cupertino, Calif. Typical video files have at least two audio channels, of which only one is usually used to record the monoscopic vocal track. When multiple video clips are assembled and cut together in an editing system, their associated audio tracks are also kept synchronized by the system, so that the audio remains locked to the picture. This makes it possible to export an entire audio track that contains the tracking data for each visual effects shot. In a preferred embodiment, this exported audio track can be saved into a standard audio file. Since the tracking data for each frame is contained within one of the audio channels for that frame, the output audio represents the collected tracking data for the entire video sequence.

The exported audio file can then be converted into a standard ASCII text file for import into post-production software tools. Since the audio encoding is a simple volume normalized 8 bit data encoding, the conversion to ASCII can be straightforward and is well understood by practitioners in the art. The target ASCII file format can be the Maya ASCII file format, created by Autodesk Corporation of San Rafael, Calif.

Thus, systems of the present disclosure can have many unique advantages such as those discussed immediately below. Since the tracking sensor 130 is self-contained, it requires no external PC to calculate the current camera pose. The use of integrated lens encoders 113 and 114 means that no additional follow focus serial interface needs to be maintained by the development group. Tracking data 392 can contain timecode, so that the tracking data can be automatically matched later in the system to the corresponding live action video frame. Furthermore, the tracking sensor can be made wireless as it does not need a high bandwidth connection to the host PC. Thus the tracking data 392 can be easily embedded into an audio stream on the camera, or connected with a simple wireless serial link. Since the complete tracking data fusion and error correction happens in microcontroller 300, the tracking data can be precisely synchronized to the genlock signal 162.

If the tracking data 392 is directly embedded into one of the audio channels of scene camera 100, it enables a multi-camera virtual shoot to be switched by feeding in all the cameras' video feeds into a standard HD switcher, and then feeding the output of the HD switcher into the computer 600. Since the tracking data in the audio channel is already synchronized with the video data, the virtual camera will automatically switch from location to location when the corresponding camera's feed is enabled or disabled. In addition, this data embedding allows all the video and tracking data to be sent over a standard production wireless video link commonly used on stages and sets.

The use of optical fiducial markers 170 means that only a small number of markers (4) need to be visible at a time for the system to have a reliable tracking output, making tracking reliable even under chaotic stage lighting conditions. Furthermore, since the total number of markers is small, this reduces the size of the bundled calculation required to solve for the overall position of all the targets during the target mapping/bundle adjustment stage, and enables the pose solves to be completed on single board computer 310.

Similarly, the use of a low-power single board computer 310 and microcontroller 300 makes it possible to have self-contained tracking using a small amount of power, typically less than 15 W. This enables operation of the tracking sensor 130 directly from the battery or power supply of scene camera 100, further reducing the on-set complexity. This embedded, low power design also makes it simple to integrate the tracking sensor 130 directly into a future model of scene camera 100.

The artist can thus avoid the difficulty of manual synchronization of three separate systems (tracking, lens data, and 3D engine.) In addition, a facility does not have to keep up with multiple separately changing hardware interfaces; the only non-standard interface that remains is the code in 3D engine plug-in 510. The HDSDI, timecode, and genlock interfaces have been standardized for decades, and are well established in the industry.

Furthermore, the adjustable tracking camera 133 makes it simple to automatically align camera 100 to tracker 130 by pointing both lenses toward fiducial targets 170 and measuring the offset between the two poses. This dramatically simplifies the alignment task, which otherwise can be very confusing to stage personnel.

In addition, since the connection between 2D compositing engine 400 and 3D rendering engine 500 is achieved on the same computer 600 through a flexible shared memory, texture transfer, or other software interface, the additional cost and complexity of a separate HDSDI interface for each component is avoided, and the data transfer between the two systems can be expanded or changed as necessary with just a few lines of code.

This advantage can be readily seen in the case of handling lens distortion, which typically requires rendering an image oversize, and then selectively shrinking the corners of the image to re-create the effect of the optical distortion process. Using a software defined transfer, it is simple to have render engine 500 create a 25% oversized image without distortion, transfer it to compositing system 400, and run distortion shader 490 on it. As this drastically simplifies the rendering calls to rendering engine 500, multiple different rendering engines can easily be connected to the system with minimal additional development. In addition, as plugin 510 only activates and renders a frame when it receives data packet 472, it means that 3D engines not originally designed for video frame rate synchronization can be made to generate a synchronized stream of images.

For similar reasons, this software connection enables the use of expanded image transfer formats, such as high dynamic range, depth maps, and other data that can be very useful in the compositing process. In addition, the inclusion of a frame number with the tracking data 472 when sent to rendering engine 500 means that the re-matching of the rendered frame 230 back to the original live action frame 220 can be automated, removing yet another area that typically requires manual adjustment in the present state of the art.

Since the 3D plugin can be pre-compiled, it is straightforward for users to add this to their game, without requiring any IP exposure from either side.

It is alternatively possible to attempt to directly integrate the code of rendering engine 500 with compositing system 400, but in practice this does not work well due to the high complexity of both code bases. The use of a separate plugin with both systems running separately but on the same computer 600 enables the best combination of compatibility and flexibility, as an update in 3D engine 500 at most requires updating a few lines of code in plugin 510.

In an alternative embodiment, it is also possible to disable keyer/despill module 420, and simply overlay distorted virtual image 492 onto live action image 220. In this case, the transparency values of the virtual image (typically called the alpha channel, and automatically generated by 3D render engine 500) are used to determine what parts of each image are displayed. This method can be used to insert a digital character into an otherwise live action scene. The digital character can be driven by pre-existing character animation, or optionally an external motion capture system. In another alternative embodiment, the shared memory connection between 2D compositing system 400 and 3D rendering engine 500 can be replaced by a high speed network between two computers, or one a long way away over the network, if the latency was low enough.

In another alternative embodiment, a depth sensor such as the Microsoft Kinect can be used for depth compositing. In this case, the depth sensor can be mounted to scene camera 100, and then the depth signal sent to compositor 440. Compositor 440 then compares the depth signal for live action image 220 with the depth of virtual image 230, and places the virtual image components in front of or behind the live action components depending on the relative depth distances of the two images.

### Summaries of Selected Aspects of the Disclosure

1. A tracking sensor that can read standard video synchronization and timecode signals, generate tracking data in precise synchronization with these signals, and stamp each data packet with the matching timecode stamp.

The video synchronization and timestamp works by using the microcontroller 300 (see FIG. 4) to receive the genlock signal 162 and the timecode signal 164, as well as the incoming pose updates from SBC 310 and the high speed inertial data from IMU 148. Since the IMU 148 is sending data very quickly (e.g., 800-2400 Hz) to microcontroller 300, it provides a very smooth data source that is corrected from drift by the pose data from SBC 310 solving the optical target locations (which would otherwise be very noisy data.) The microcontroller 300 can then read what the current smoothed pose is at the exact instant that the genlock signal 162 arrives, and associate it with the exact timcode stamp that is also being read at that moment. The time accuracy of the data is thus fixed properly from the beginning, and should not require adjustment down the line, dramatically simplifying system operation.

2. A tracking sensor that can embed tracking data directly into the main camera recording, either through a data or an audio connection.

Since the camera pose is calculated at the exact instant that the genlock signal 162 is received (due to the high rate of the updates of IMU 148 being read by microcontroller 300), the tracking data 392 has zero delay, and can be embedded directly into the camera signal as either a real time serial data packet or an audio signal, and will be correctly synchronized to the current video frame. This means that the data is correctly time-aligned at the beginning of the process, dramatically simplifying synchronization of tracking data with the associated video frame further down the process.

3. A tracking sensor that can embed tracking data directly into the video stream, and thus enable seamless multicamera switching with matching tracking information.

Since the tracking data with timecode 392 can be embedded directly into the video stream at the camera during recording, the complete information required to render a virtual set is contained within the actual frame of video that is being passed through the live camera output. In this way, a standard HD camera switcher, when used to switch between multiple live camera signals, will also automatically switch the associated tracking data along with the camera signal. If the virtual scene preview system is set up to read the embedded tracking data within the video signal, the 3D background will automatically change its perspective to match that of the current live camera view.

4. A scene preview system that can automatically synchronize camera and lens tracking data to the live action video and 3D virtual components, without hand adjustment by the user.

Referring to FIG. 6, since the incoming tracking data 392 and the incoming video image 220 both have timecode embedded with them, the tracking data and video image can be automatically synchronized by comparing their respective timecode stamps. When the timecode matches, the data and the video will be correctly aligned. This saves an enormous amount of user interface complexity which otherwise must be used to manually set the various delays between components.

5. A scene preview system that can integrate with 3D render engines without requiring them to be designed to run at specific frame rates.

The use of a compositing application 400 and a 3D rendering engine 500 running on the same computer 600 (as shown in FIG. 6) means that the plugin 510 can generate rendered frames on demand by compositing application 400. Since compositing application 400 can be driven by the incoming video frames 220 and tracking data packets 392, both of which arrive at the precise time intervals used by video frame rates, the 3D engine 500 does not need to run precisely at the unusually precise frame rates required by professional video systems. The timing is handled by the compositing application 400, enabling a much wider range of 3D rendering engines to be supported by the system.

6. A scene preview system that stores tracking data for post-production in an audio channel of the output composited image, and thus does not require a separate tracking metadata file.

Since the compositing application 400 generates the final output image 240 (see FIG. 6), and sends it out over the video capture card 410, it is straightforward to convert the associated tracking data packet into an audio waveform, and place this in the audio channel of the outgoing video image 240. When the live output image 240 is recorded, the audio is automatically recorded as well (as nearly all video recorders also record the audio channels), and thus the tracking data can be automatically transported along with the video data, with no need for an external metadata file that can be easily lost or deleted.

7. A scene preview system that lets editors edit the composited video in post production, and automates the extraction of tracking data from the resulting edited sequence.

Since the tracking data can be embedded into an audio channel of the output image 240, and this audio channel is automatically recorded along with the video channel by most video recorders, the audio tracking data will be imported along with the video into a typical video editing system. Video editing systems are designed to keep the audio tracks aligned with the video tracks, to preserve lip synchronization, so they will also keep the tracking audio synchronized. When the editor is done editing, they can simply export an audio clip of the edited sequence, and the tracking data from that series of shots can be reconstructed by passing the audio file through a tracking data extractor piece of software that works similarly to a modem using algorithms well understood by practitioners in the field.

Although the inventions disclosed herein have been described in terms of preferred embodiments, numerous modifications and/or additions to these embodiments would be readily apparent to one skilled in the art. The embodiments can be defined, for example, as methods carried out by any one, any subset of or all of the components as a system of one or more components in a certain structural and/or functional relationship; as methods of making, installing and assembling; as methods of using; methods of commercializing; as methods of making and using the terminals; as kits of the different components; as an entire assembled workable system; and/or as sub-assemblies or sub-methods. The scope further includes apparatus embodiments/claims of method claims and method embodiments/claims of apparatus claims. It is intended that the scope of the present inventions extend to all such modifications and/or additions and that the scope of the present inventions is limited solely by the claims set forth below.

1. A tracking sensor comprising:
an inertial measurement unit;
a computing device;
a controlling device configured to receive genlock signals, timecode signals, and pose updates from the computing device and high speed inertial data from the inertial measurement unit;
the controlling device being configured to drift-correct the pose updates using the high speed inertial data to form smoothed video pose data; and
the controlling device being configured to read the smoothed pose when the genlock signal arrives and associate the smoothed pose with the timecode signal being read at the same time and generate tracking data packets synchronized with the genlock and timecode signals and stamp each data packet with the timecode stamp associated with the timecode signal.

2. The tracking sensor of claim 1 wherein the controlling device is configured to send the timecode stamped data packets to a real time compositing system.

3. The tracking sensor of claim 1 wherein the genlock signals are received from a sync generator associated with a multi-camera video production.

4. The tracking sensor of claim 1 wherein the timecode signals are received from a timecode generator associated with a multi-camera video production.

5. The tracking sensor of claim 1 wherein the controlling device is configured to read the rotary position of an encoder at the same time as the pose.

6. The tracking sensor of claim 1 wherein the computing device is configured to read images from a tracking camera.

7. The tracking sensor of claim 1 wherein the controlling device is a real time micro-computer.

8. The tracking sensor of claim 1 wherein the high speed inertial data is 800-2400 Hz.

9. A method comprising:
sending a composited output image out over a video capture card;
converting a camera and lens tracking data packet associated with the composited output image into an audio waveform;
inserting the audio waveform into an audio channel of a video image of the output image;
simultaneously recording the composited output image and the audio waveform contained in the video image; and
after the recording, transporting the tracking data along with the video data.

10. The method of claim 9 wherein the transporting does not use an external metadata file.

11. The method of claim 9 wherein the transporting is to a video editing system.

12. The method of claim 9 wherein the transporting includes digitally copying the video file.

13. The method of claim 9 further comprising before the sending, compositing the output image from a live action scene camera and a 3D rendering engine.

14. A method comprising:
video editing a composited video having tracking data embedded in an audio channel of an output image of the video;
exporting an audio clip of an edited sequence of the edited composited video; and
reconstructing the tracking data from the audio clip using a tracking data extractor.

15. The method of claim 14 wherein the extractor is extractor software and the reconstructing includes passing the audio clip through the extractor software.

16. The method of claim 14 further comprising after the reconstructing, using the tracking data to render a set of high quality images of a 3D scene to replace the original real time rendered 3D images.

17. The method of claim 14 wherein the editing uses a video editing system that keeps the tracking audio synchronized with the video.

18. The method of claim 14 wherein the editing uses a video editing system, and further comprising before the editing, importing the composited video along with the tracking data into the video editing system.

19-65. (canceled)
